(19) United States
(12) Patent Application Publication
(10) Pub. No.: US 2026/0236381 A1
(43) Pub. Date: Aug. 13, 2026

(54) TEST CASE FACTORIZATION OPTIMIZATION

(71) Applicant: International Business Machines Corporation, Armonk, NY (US)

(72) Inventors: Ji Dong Li, Beijing (CN); Yu Long Zhang, Beijing (CN); JING ZHANG, POUGHKEEPSIE, NY (US); Peng Hui Jiang, Beijing (CN); Mai Zeng, Shi Jing Shan (CN)

(73) Assignee: International Business Machines Corporation, Armonk, NY (US)

(21) Appl. No.: 19/053,089

(22) Filed: Feb. 13, 2025

(51) Int. Cl. G06F 11/3668

(52) U.S. Cl. CPC G06F 11/3688; G06F 11/3684

(57) ABSTRACT

An embodiment decomposes each test case of a set of test cases into a set of test case units. The embodiment constructs a graph data structure based on the set of test case units, wherein each path of the graph data structure corresponds to a test case of the set of test cases. The embodiment detects a first test case scenario, wherein the first test case scenario corresponds to a first portion of the set of test cases. The embodiment traverses, upon detection of the first test case scenario, a first portion of paths of the graph data structure, wherein traversing a path of the first portion of paths causes assembling a test case of the first portion of test cases. The embodiment executes each test case assembled as a result of each path traversal of the first portion of paths of the graph data structure.

### BACKGROUND

The present invention relates generally to software testing. More particularly, the present invention relates to a method, system, and computer program for test case factorization optimization.

Software testing is the process of systematically evaluating a software application to ensure that a particular application or component meets specified requirements, functions as intended, and/or is free of defects. Software testing typically involves executing software in a controlled environment to identify errors, gaps, or missing functionality relative to the expected outcomes. Software testing can involve various methodologies, which may include, but are not limited to, manual testing, automated testing, functional testing, performance testing, and more.

In the context of software testing, test cases are specific, predefined conditions or sets of steps designed to verify whether a software application or component behaves as expected under certain inputs, environments, and/or scenarios. A test case typically includes test inputs, execution conditions, and expected results. Accordingly, test inputs may include data or actions to be applied to the system, execution conditions may include preconditions or system states required for the test, and expected results may include the anticipated outcome if the system, application, or component functions correctly. Test cases may be used to identify bugs or discrepancies in behavior to ensure that the software meets requirements and functions as intended.

In the context of computer data structures, a graph is a data structure comprising of nodes (or vertices) that represent data points, and edges that represent connections or relationships between nodes. Graphs are a highly efficient way to factor and store similar data by leveraging their ability to represent relationships and shared connections. When data shares common attributes or relationships, a graph can eliminate redundancy by storing these shared elements only once and linking them appropriately.

### SUMMARY

The illustrative embodiments provide for test case factorization optimization. An embodiment includes decomposing each test case of a set of test cases into a set of test case units. The embodiment also includes constructing a graph data structure based on the set of test case units, wherein each path of the graph data structure corresponds to a test case of the set of cases. The embodiment also includes detecting a first test case scenario, wherein the first test case scenario corresponds to a first portion of the set of test cases. The embodiment also includes traversing, upon detection of the first test case scenario, a first portion of paths of the graph data structure, wherein traversing a path of the first portion of paths causes assembling a test case of the first portion of test cases. The embodiment also includes executing each test case assembled as a result of each path traversal of the first portion of paths of the graph data structure.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of an example computing environment in accordance with an illustrative embodiment;

FIG. 2 depicts a block diagram of an example computing environment in accordance with an illustrative embodiment;

FIG. 3 depicts a block diagram of an example test case factorization optimization software module in accordance with an illustrative embodiment;

FIG. 4 depicts a block diagram of an example system architecture in accordance with an illustrative embodiment;

FIG. 5 depicts a graph diagram of an example process for test case factorization optimization in accordance with an illustrative embodiment; and

FIG. 6 depicts a flow chart of a process for test case factorization optimization in accordance with an illustrative embodiment.

### DETAILED DESCRIPTION

Currently existing software testing methodologies are inefficient for various reasons. For example, software testing includes storing vast amounts of data corresponding to test cases. Further, this data may include many redundant and/or duplicate software tests stored on a system or organization's test case database.

The inefficiencies of currently existing methods of software testing are due to various reasons. For example, testers and developers spend unnecessary time executing redundant tests, reducing the time available for other essential activities such as creating new tests or fixing defects. Further, automated test suites running duplicate tests consume more computational resources, leading to longer execution times and increased costs, especially in cloud-based or large-scale systems.

Further, duplicate tests may lengthen the overall testing process, which delays feedback to developers, slowing down the development cycle and increasing the time needed to identify and fix issues. Even further, redundant tests may create a misleading perception of thorough testing since teams or automated systems might mistakenly believe the system has been extensively tested, when in reality, the duplicate tests offer no additional value.

Further, maintaining duplicate tests increases development effort and complexity. As a codebase evolves, storing redundant tests up to date requires additional work, making test maintenance more challenging and prone to errors. Accordingly, a bloated test suite with duplicates becomes harder to scale, especially as the codebase and test suite continues to grow. Further, when duplicate tests fail, they can produce redundant failure reports, which creates unnecessary noise in test results. Overall, time and resources spent on duplicates could be better utilized to create new, high-value tests that explore untested areas of the application, improving overall test coverage and software quality.

Accordingly, these inefficiencies described above may be addressed at least in part by the development of more sophisticated techniques that leverage test case factorization and refactorization through an iterative optimization process. By overcoming the inefficiencies of currently existing methods, systems and organizations can achieve more efficient and cost-effective computer resource management for execution of software tests. The following disclosure addresses the deficiencies described above and includes an iterative refactorization technique for storing and executing software tests.

Accordingly, the present disclosure addresses the deficiencies described above by providing a process (as well as a system, method, machine-readable medium, etc.) that develops a system for test case factorization optimization. In an embodiment, the process employs a software module designed to optimize software test case factorization and test case deployment across a computer network environment. The inputs to the test case factorization module may include various types of software tests that may be executed across a computer environment to test the functionality of various applications and/or components of the system. By analyzing these inputs, the process generates and outputs a graph-based data structure that efficiently stores software tests. The output graph of the process provides an efficient data storage scheme for software tests that reduces and/or eliminates the presence of unnecessary, redundant, and/or duplicate code associated with software tests stored on the graph structure.

There are currently no existing systems or methods that consider test case factorization, graph-based storage, and iterative weighted automated software testing. In some embodiments, software test execution described herein may be optimized for maximum coverage of relevant software tests. However, the use of this example is only meant to be illustrative, and the optimization goal may include other types of specified optimization goals, such as for example, minimizing computer resource and/or power consumption for deployment and execution of software tests, prioritizing important or critical software tests given limited execution resources, and so forth. In some embodiments, the specified optimization goal includes any optimization goal specified by a user having sufficient privileges.

In an embodiment, the system may include a test case factorization module configured to factorize test cases into test case units. Further, in an embodiment, the test case factorization module may be configured to construct a graph data structure from the test case units. Further, in an embodiment, the test case factorization module may be configured to execute test cases automatically by traversing paths of the graph data structure. In an embodiment, the test case factorization module includes a monitor module, an analysis module, a decomposer module, a mapping module, a graph module, an assembly module, and an optimization module.

The following description provides examples of embodiments of the present disclosure, and variations and substitutions may be made in other embodiments. Several examples will now be provided to further clarify various aspects of the present disclosure.

Example 1: A computer-implemented method that comprises decomposing each test case of a set of test cases into a set of test case units. The method further comprises constructing a graph data structure based on the set of test case units, such that each path of the graph data structure corresponds to a test case of the set of test cases. The method further comprises detecting a first test case scenario, such that the first test case scenario corresponds to a first portion of the set of test cases. The method further comprises traversing, upon detection of the first test case scenario, a first portion of paths of the graph data structure, such that traversing a path of the first portion of paths causes assembling a test case of the first portion of test cases. The method further comprises executing each test case assembled as a result of each path traversal of the first portion of paths of the graph data structure.

The above limitations advantageously enable efficient storage and execution of test cases. Accordingly, factorizing test cases into test case units and storing test cases as sequences of test case units along a graph data structure greatly reduces the amount of data storage resources required to store the same number of test cases using traditional means. Further, factorizing test cases into test case units and storing test cases as sequences of test cases units prevents the inclusion of duplicate and/or redundant test cases from populating a test case database storing test cases. Even further, leveraging a graph data structure to execute test cases in response to detection of a test case scenario provides for efficient test case execution such that efficiency is maximized according to a user specified graph traversal algorithm.

Example 2: The limitations of Example 1, further comprising assigning each node of the graph data structure a weight value based on a number of connections to other nodes.

The above limitations advantageously enable prioritization of critical functionalities, scenarios, or test cases based on their importance, complexity, and/or frequency of execution. This prioritization allows for more efficient allocation of testing resources, focusing on high-impact areas of the software system. Further, the weight values provide a quantitative measure of the significance of each node, guiding the testing strategy and optimizing the testing sequence.

Example 3: The limitations of Example 2, wherein the number of connections to other nodes corresponds to a number of connections to child nodes.

The above limitations advantageously enable the prioritization of nodes that have a significant influence on the overall system behavior or testing coverage. This approach enables the testing framework to limit testing to test cases that have a higher impact on the system's functionality. By assigning weight values based on connections to child nodes, the testing process becomes more targeted, efficient, and effective in identifying and addressing the most relevant areas of the software system.

Example 4: The limitations of Example 2, wherein the number of connections to other nodes corresponds to a number of connections to parent nodes.

The above limitations advantageously enable the prioritization of nodes with multiple dependencies. Accordingly, nodes with multiple connections to parent nodes may represent central components or critical functionalities that influence various parts of the software system. By assigning weight values based on connections to parent nodes, the testing process considers the hierarchical structure and dependencies within the software system, facilitating targeted testing, efficient resource allocation, and comprehensive validation of key components.

Example 5: The limitations of Example 2, wherein the number of connections to other nodes corresponds to a combination of child nodes and parent nodes connected to the node.

The above limitations advantageously enable a comprehensive assessment of the importance and influence of each node within the graph data structure. Nodes with a high number of connections to both parent and child nodes are likely to represent pivotal decision points in the software system. Assigning weights based on this combined metric allows for a nuanced prioritization of nodes that have a substantial impact on the overall system behavior and testing coverage. By assigning weight values based on a combination of connections to parent and child nodes, the testing process considers a holistic view of the interdependencies within the software system.

Example 6: The limitations of Example 2, wherein traversing each path of the first portion of paths of the graph data structure is executed in a sequence based at least in part on a cumulative weight value corresponding to execution of each path.

The above limitations advantageously enable prioritization of execution of test cases. Prioritizing execution of test cases is especially important for efficient resource consumption when performing software testing. Accordingly, paths with higher cumulative weights values may be executed prior to paths with relatively lesser cumulative weight values. By prioritizing execution of test cases by traversing paths with higher cumulative weight values, more important tests may be executed ahead of less important tests, based on a user specification. For example, more compressive tests, such as those with greater coverage, may be executed in favor of less comprehensive tests, such as niche tests that may have lesser impact on the particular software system or component being.

The illustrative embodiments provide for test case factorization optimization. As used throughout the present disclosure, the term “test case” refers to a set of specific conditions, inputs, and/or expected results designed to evaluate whether a particular feature or functionality of a software application behaves as intended. In an embodiment, a test case includes a test case identifier corresponding to a unique name and/or number for identifying, tracking, and/or referencing a particular test case, a test objective description including description of what the test is intended to validate, and/or a set of precondition and/or prerequisites or setup required before executing the test. Further, a test case may comprise a series of test steps, or sequence of actions or inputs to be performed, as well as test data, which may include specific inputs to be used in the test. Further, a test case may include expected results, which may include the anticipated outcomes or behaviors if the software is functioning correctly, as well as postconditions, including the state of the system, application, or component after the test is executed.

As used throughout the present disclosure, unless otherwise defined by the context, the term “application” refers to any type of software application that may be wholly or partly executed over a computing resource unit. It is understood that terms “system”, “application”, “component”, and/or “software” may be used in combination with each other and/or interchangeably depending on the context.

As used throughout the present disclosure, the term “atomic test unit” refers to the smallest indivisible unit of a test case that represents a single, discrete functionality or behavior to be tested within a software system. In some embodiments, atomic test units may be independent and self-contained, and configured for testing a specific aspect or feature of the system in isolation. Accordingly, an atomic test unit is not further subdivided into smaller test case units, and serves as a fundamental building block for constructing more complex test cases. Further, atomic test units may be utilized for granular testing, enabling precise validation of individual functionalities and facilitating targeted debugging and analysis during the testing process.

In an embodiment, a test case can be assembled from a chain of atomic test units stored on a graph data structure by traversing the graph data structure and sequentially combining the atomic test units along a specific path or sequence. In some embodiments, the graph data structure organizes the atomic test units hierarchically, with each unit representing a specific functionality or behavior to be tested. To assemble a test case, an embodiment of the disclosed process beings at a root of a graph and follows a path that connects a series of atomic test units in a logical order. As the traversal progresses down the down, each atomic test unit along the path is added to the test case chain, forming a sequence of test steps that collectively validate a particular scenario or functionality within the software system.

By storing atomic test units on a graph data structure, such as a tree or a directed acyclic graph (DAG), the organization and relationships between different test units are clearly defined, allowing for systematic assembly of test cases based on the desired testing criteria and/or test case scenarios. This approach enables efficient test case storage, assembly, and execution, and ensures comprehensive coverage of different functionalities, as well as facilitates the reusability of atomic test units across multiple test cases within the testing framework.

As used throughout the present disclosure, the term “Coverage Weight” (or simply “C_{weight)}” refers to a quantitative measure assigned to nodes within a graph data structure in the context of software testing. In some embodiments, the Coverage Weight represents the significance and contribution of each node towards achieving comprehensive testing coverage. In some embodiments, Coverage Weight may be calculated based on factors such as, for example, the number of associated test cases, criticality of functionalities represented by the node, and frequency of node traversal during testing. Accordingly, assigning Coverage Weight may be useful to prioritize testing efforts, allocate resources effectively, and optimize testing coverage by ensuring that nodes with higher weights receive greater attention during the testing process.

In an embodiment, the process of assigning weight to nodes of a tree to establish a Coverage Weight for each node involves a systematic approach to determine the significance and coverage contribution of individual nodes within the graph structure. In an embodiment, this process begins with a coverage analysis, where factors such as the number of associated test cases, the criticality of functionalities represented by each node, and the frequency of node traversal during testing are considered to assess the coverage impact. Subsequently, weight calculation may be performed to compute the C_{weight} for each node based on the coverage analysis findings, ensuring that the assigned weights accurately reflect the importance of nodes in achieving comprehensive testing coverage.

In an embodiment, the C_{weight} values of nodes are fine-tuned based on their relationships with other nodes, shared functionalities, and testing dependencies, with nodes shared among multiple test cases or those with a higher coverage impact potentially receiving elevated C_{weight} values. Additionally, hierarchical weighting may be applied to consider the hierarchical structure of the graph data structure, ensuring that parent and child nodes are assigned appropriate C_{weight} values that align with testing priorities and critical paths within the graph. By assigning C_{weight} to nodes in this manner, the testing process can effectively prioritize relevant functionalities, optimize testing coverage, and allocate resources efficiently to enhance the overall quality and reliability of the software system. In some embodiments, C_{weight} values of nodes are fine-tuned through an iterative adjustment process, as described in greater detail herein.

In an embodiment, weighted automated testing is performed in part by calculating the weights of test units within each node of the graph structure. As discussed, this calculation may first involve assigning weights to individual test units based on specific criteria such as coverage significance, criticality, or importance in achieving comprehensive testing coverage. Subsequently, in the automated testing phase, all test cases may be automated based on the principle of coverage first or importance first, depending on the specific requirements of users. In the coverage-first approach, automated testing prioritizes test cases that cover a wider range of functionalities and scenarios to ensure thorough testing coverage across the software system. On the other hand, the importance-first approach focuses on automating test cases that address critical functionalities or high-priority areas of the system to mitigate risks and ensure the reliability of essential features. By automating test cases according to the principles of coverage first or importance first, weighted automated testing optimizes testing efficiency, prioritizes critical testing areas, and aligns testing efforts with the specific needs and priorities of users.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

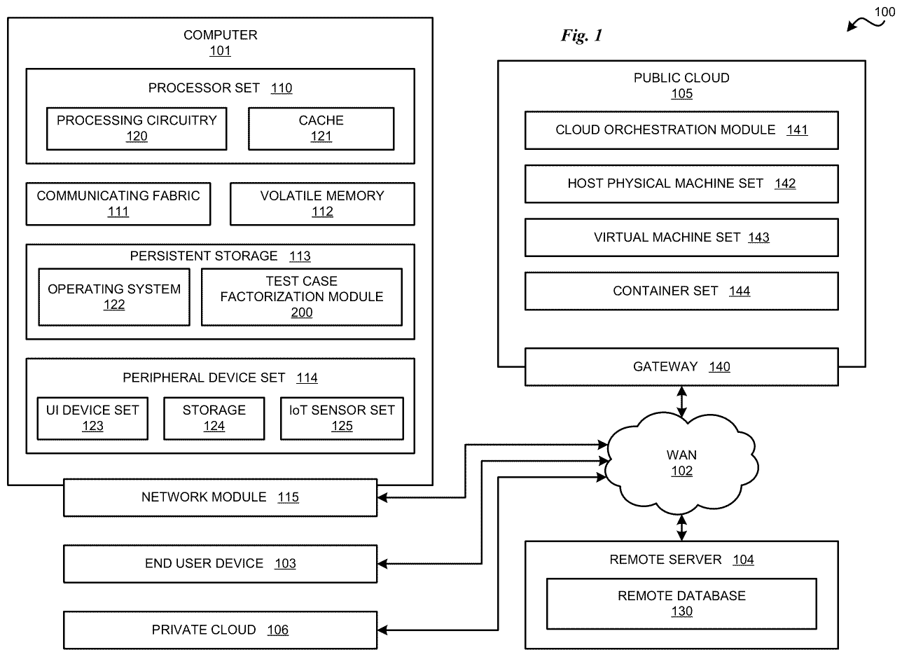

With reference to FIG. 1, this figure depicts a block diagram of a computing environment 100. Computing environment 100 contains an example of an environment for the execution of at least some of the computer code involved in performing the inventive methods, such as a test case factorization module 200 may be configured to factorize a set of test cases into test case units and automatically execute some or all of the set of test cases in part by traversing one or more paths of a graph data structure storing test case units corresponding to the set of test cases. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

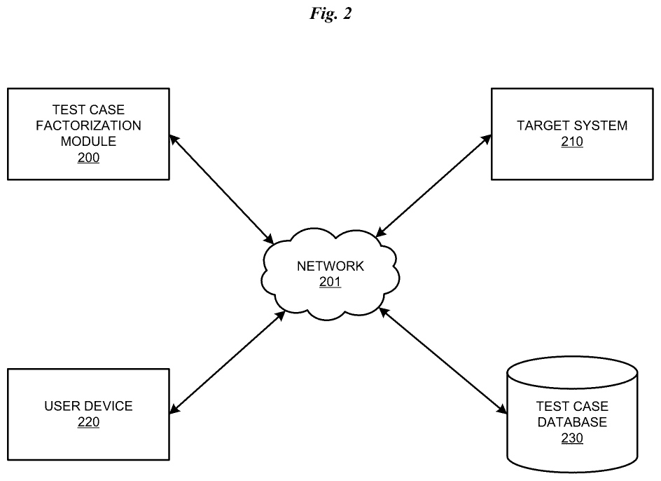

With reference to FIG. 2, this figure depicts a block diagram of an example computing environment in accordance with an illustrative embodiment. In the illustrated embodiment, the computing environment includes the test case factorization module 200 of FIG. 1.

In the illustrated embodiment, the test case factorization module 200 is configured to construct a graph data structure from test cases stored on test case database 230. In an embodiment, the module 200 is configured to execute a process for test case refactorization based on test case data stored on test case database 230. In an embodiment, the process for test case factorization (and refactorization) includes decomposing a set of test cases into smaller test units and constructing a graph data structure to store these units as nodes of the graph. Further, the process includes trimming existing test cases, creating a hierarchical structure based on specified criteria, subdividing testing functions, merging duplicate modules, and creating shared test units. In the illustrated embodiment, the user device 220, the test case factorization module 200, the target system 210, and the test case database 230 may each communicate and interact with each other via any suitable network 201 to perform the following example operations in accordance.

In an embodiment, the process for test case factorization further includes optimizing the test case graph structure. In an embodiment, the optimization process for test case refactorization includes constructing a test case graph and assigning different weights to each test unit based on one or more algorithms. In some embodiments, upward iterative optimization is performed on all test units to create more efficient and reasonable minimum test units. Further, different weight values may be assigned to each minimum test unit based on one or more algorithms. In an embodiment, weighted automated testing may be executed based on user requirements and the weight values of test units. The automated assembly and testing of weight-based test cases may be specified according to user requirements and the assigned weight values to ensure comprehensive testing coverage.

As discussed in greater detail herein, weighted automatic testing refers to a testing approach where test cases are prioritized and executed based on assigned weights to each test unit. These weights may be determined using specific algorithms and criteria to reflect the importance or complexity of the test units. Weighted automatic testing may include automated assembly and execution of test cases according to the assigned weight values. By utilizing this approach, testing may be executed more efficiently and/or be focused on important or critical areas of the system, ensuring thorough testing coverage while optimizing utilization of testing resources and maximizing efficiency.

In an embodiment, the process of creating initial minimum testing units includes collecting user behavior data and analyzing relevant test scenarios to align user behavior with the testing steps in each test scenario individually. Further, an embodiment includes constructing a mapping defining a relationship between user behavior and testing steps. In an embodiment, during the testing process, a complete test chain may be constructed by assembling atomic test units with varying levels and functions. In an embodiment, assembling atomic test units into test chains for automated testing includes combining the initial minimum testing units into a comprehensive test chain that covers different levels and functions of the system. By creating this interconnected structure of test units, the testing process can address various aspects of the system's functionality and interactions, ensuring thorough testing coverage across different scenarios and user behaviors.

In an embodiment, the optimization process may include assigning weight values to atomic test units. In an embodiment, assigning weight values to atomic test units serves the purpose of prioritizing and optimizing the testing process. These weight values are assigned based on specific criteria, such as the complexity, criticality, or importance of each atomic test unit. By assigning weight values, the testing process can focus on executing and validating the most critical and high-priority test units first, ensuring that essential functionalities are thoroughly tested. This prioritization helps in efficient resource allocation, time management, and overall testing effectiveness. Additionally, weight values aid in identifying and addressing potential risks or vulnerabilities in the system by emphasizing testing on key areas that have a significant impact on the system's performance and reliability.

In an embodiment, the assigned weights for test units are updated based on the consideration of shared test units and their impact on testing coverage. For example, when a minimum test unit is part of a shared test unit, this implies that this particular test unit will be included in multiple test chains, increasing the probability of it being tested during coverage testing across various scenarios. For example, in the scenario where the smallest test unit is associated with a shared test unit, the assigned weight of the test unit is adjusted by multiplying it by a corresponding factor based on the number of times this test unit has been shared. This adjustment accounts for the increased likelihood of the test unit being executed multiple times due to its presence in shared test units, ensuring that its weight reflects its importance and frequency of testing across different test chains. By updating the weights in this manner, the testing process can effectively prioritize shared test units and allocate resources based on their significance in achieving comprehensive testing coverage.

In the illustrated embodiment, the target system 210 includes a software development environment. Further, in an embodiment, the target system 210 includes a code repository in the corresponding to the software development environment. In an embodiment, a user may use user device 220 to cause test factorization module 200 to execute a process mining technique can monitor changes made to a code repository of target system 210 to and detect user behaviors and test cases executed in response to detected changes made to the code repository, as well as to further create a mapping defining relationships between detected changes to the code repository and test cases executed. In an embodiment, the mapping may be further leveraged to facilitate automatic testing, as described in greater detail herein.

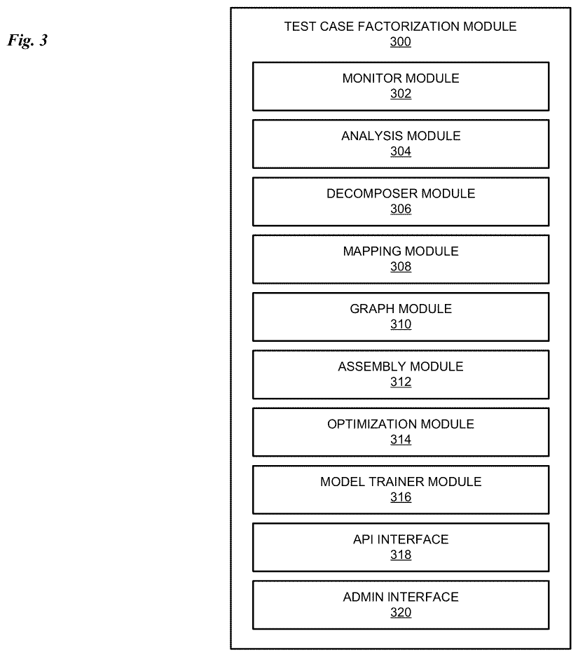

With reference to FIG. 3, this figure depicts a block diagram of an example test case factorization module in accordance with an illustrative embodiment. In an embodiment, the test case factorization module 300 includes a software module comprising a plurality of other connected software modules. In an embodiment, the test case factorization module 300 includes a monitor module 302, an analysis module 304, a decomposer module 306, a mapping module 308, a graph module 310, an optimization module 314, a model trainer module 316, an API interface module 318, and an administrator interface module 320.

In the illustrated embodiment, the monitor module 302 is configured to monitor changes made to a code repository corresponding to a particular software system, application, and/or component. Further, in an embodiment, the monitor module 302 is configured to monitor and collect data related to user behavior and actions taken upon detection of changes made to a code repository. In an embodiment, the monitor module 302 continuously monitors modifications within the code repository and captures user interactions and responses triggered by these changes.

In the illustrated embodiment, the analysis module 304 is configured to analyze data collected by the monitor module 302 to determine user behaviors and software test cases that are executed in response to changes made in the code repository. In an embodiments, the analysis module 304 processes the monitored data to identify user behaviors and software test cases that are executed following changes in the code repository. Through data analysis, the analysis module 304 discerns patterns, trends, and correlations between user actions and the specific software test cases initiated as a result of code modifications.

In the illustrated embodiment, the decomposer module 306 is configured for breaking down test cases into smaller test units. In an embodiment, the decomposition process involves analyzing the structure and content of the test cases to identify individual functionalities, behaviors, or scenarios that can be isolated. In an embodiment, the decomposer module 306 analyzes the existing test cases, identifies individual functionalities or behaviors, and decomposes the test cases into atomic test units. In an embodiment, the decomposer module 302 interacts with the assembly module 312 by providing the decomposed test units for assembly into coherent test cases.

In the illustrated embodiment, the mapping module 308 is configured for constructing a mapping between software tests and changes made to a code repository, such that the mapping defines specific types of changes made to a code repository with specific types of software tests executed to evaluate functionality of the application or component after changes to the corresponding code have been implemented. By defining this mapping, the module outlines the specific types of code changes and the corresponding tests required to validate these modifications. Accordingly, the monitor module 302 collects data on code repository changes and user behavior, providing input for the analysis module 304. The analysis module 304 processes this data to determine user behaviors and associated test cases, which are then utilized by the mapping module 308 to establish a mapping between code changes and software tests.

In the illustrated embodiment, the graph module 310 is responsible for structuring the test cases and test units within a graph data structure. It stores the test units as nodes in the graph, establishing relationships between different test units and facilitating visualization of the test case hierarchy. The graph module 310 interacts with the assembly module 304 to receive the assembled test cases for structuring within the graph and with the optimization module 308 to optimize the graph structure based on assigned weights.

In the illustrated embodiment, the assembly module 312 receives the atomic test units generated by the decomposer module 312 and assembles the atomic test units into meaningful test cases. In an embodiment, the assembly module 312 combines the individual test units in a logical sequence to create comprehensive test scenarios that cover specific functionalities or user behaviors. In an embodiment, the assembly module 312 interacts with the graph module 306 to structure the assembled test cases within the graph data structure.

In the illustrated embodiment, the optimization module 314 is configured to optimize the test case graph data structure. In an embodiment, the optimization module 308 is configured to optimize the test case graph data structure by assigning weights to nodes based on specific algorithms and criteria. In some embodiments, the optimization module 314 iteratively refines the weights of test units to prioritize critical functionalities and/or enhance testing coverage. The optimization module 314 interacts with the graph module 306 to access the structured graph data, adjust the weights of nodes, and optimize the overall graph structure for efficient testing. In some embodiments, the decomposer module 306, assembly module 312, graph module 310, and optimization module 314 are configured to work collaboratively to decompose, assemble, structure, and optimize test cases within the test case factorization module 300, ensuring thorough testing coverage, efficient testing processes, and effective management of test case complexities.

In the illustrated embodiment, the model trainer module 316 is configured to execute automatic iteration and updating of the entire model according to a specified algorithm within the test case factorization system. This module ensures that the testing structure remains real-time and stable as new test cases are added to the system. In an embodiment, the model trainer module 316 utilizes the specified algorithm to automatically iterate through the existing model, incorporating any new test cases that have been added to the system. By iterating through the model, the trainer module 316 updates the structure to accommodate the new test cases, thereby ensuring that the testing framework remains up-to-date and reflective of the current testing requirements. Also, through this iterative process, the model trainer module 316 maintains the stability and integrity of the testing structure by adjusting the model to incorporate the new test cases while preserving the existing relationships and hierarchies within the system.

In the illustrated embodiment, administrator interface module 310 enables a user with sufficient administrative privileges to adjust a any or all of settings and configurations within the test case factorization system. Some examples functions provided by administrator interface module 310 may include, but are not limited to, the ability to customize the system according to specific requirements, manage user access and permissions, configure system behavior, integrate with external tools, ensure security measures, and optimize testing processes for efficient and effective software testing operations. In an embodiment, administrator interface 320 allows administrative users to adjust the weighting scheme or weights of nodes within the test case factorization system through a range of customizable actions. Accordingly, an authorized users can configure the weighting scheme by defining the criteria and algorithms used to assign weights to nodes, tailoring the scheme to specific testing objectives. Within the administrator interface 320, administrators can directly adjust the weights of individual nodes in the graph structure, increasing or decreasing weights based on the nodes' importance, criticality, or coverage significance. This customization allows users to align the weighting scheme with the organization's unique testing priorities and strategies. The module enables real-time updates to node weights, so that the weighting scheme remains current and reflective of evolving testing requirements or the addition of new test cases. Further, authorized users can validate the adjustments made to the weighting scheme through the administrator interface 320 confirming that the assigned weights align with the intended testing goals and objectives. By offering this functionality, the administrator interface module 320 provides administrators with the flexibility, control, and precision needed to optimize testing coverage, prioritize critical functionalities, and enhance the efficiency and effectiveness of the testing framework.

In the illustrated embodiment, API interface module 318 is configured to facilitate communication and interaction between the test case factorization system and external software applications or systems through Application Programming Interfaces (APIs). This module acts as a bridge that enables the test case factorization system to communicate with external software components, tools, or services involved in the automated testing process. By leveraging APIs, the API interface module 314 allows the test case factorization system to retrieve test data, execute test cases, receive testing results, and perform other testing-related operations with external systems. In particular, the module enables the system to fetch relevant test data from external sources, trigger the execution of automated test cases on external testing platforms, capture and process testing results, integrate with third-party testing tools, and automate testing processes through seamless API interactions. Accordingly, the API module 314 serves as a communication interface that connects the test case factorization system with external software entities.

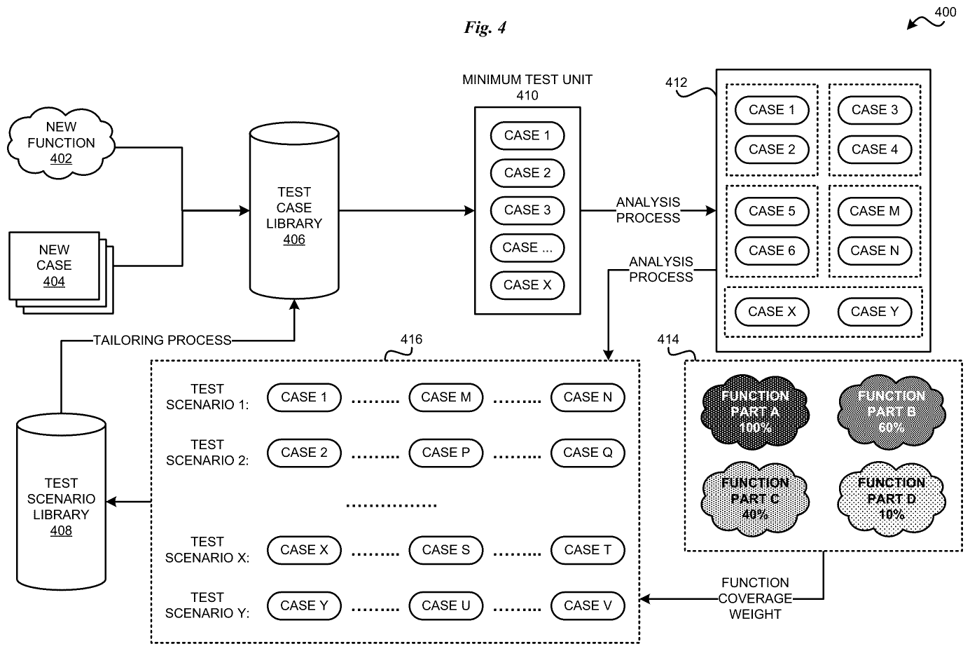

With reference to FIG. 4, this figure depicts a block diagram of an example system architecture in accordance with an illustrative embodiment. In an embodiment, the system 400 includes test case factorization module 200 of FIGS. 1 and 2 and/or test case factorization module 300 of FIG. 3.

In the illustrated embodiment, the test case library 406 stores data existing to existing test cases. Further, when one or more new functions 402 and/or new cases 404 is received by the test case library, the test case 406 is decomposed into minimum test units 410. Further, the resulting minimum test units 410 are analyzed to construct various test case groups 412. In an embodiment, the system 400 involves a process where original test functions and test cases stored in a test case library 406 are received and decomposed into minimum test units. These minimum test units are then assembled and organized into test cases groups 412 according to their respective functions.

In an embodiment, the system 400 begins by receiving the original test functions and test cases from the test case library 406. The decomposition process involves breaking down the test cases into minimum test units that represent individual functionalities or behaviors to be tested. This decomposition step aims to reduce test cases into their smallest indivisible parts, which then may be reassembled during the testing process.

Accordingly, once the test cases are decomposed into minimum test units, the system 400 assembles these units into test cases grouped according to their respective functions. This assembly process involves combining the minimum test units in a logical sequence to create comprehensive test cases that cover specific functionalities or behaviors within the software system. By grouping the minimum test units based on their functions, the system ensures that the test cases are organized and structured according to the intended testing objectives. The system 400 facilitates the decomposition of test cases into minimum test units and the subsequent assembly of these units into test cases grouped by their respective functions.

In an embodiment, at block 416, after the test cases are assembled based on their respective functions, the test cases can be further grouped according to different test scenarios to organize and categorize the testing process effectively. Grouping test cases according to different test scenarios allows for targeted testing of specific user interactions, functionalities, or system behaviors under varying conditions or use cases. In an embodiment, the scenario grouping process includes identifying different test scenarios, such that each test scenario represents a specific user interaction, system behavior, or functional requirement that needs to be tested. These scenarios are identified based on the software system's specifications, user behaviors, or testing objectives. Further, the assembled test cases are mapped to the corresponding test scenarios based on the functionalities or behaviors they cover. This mapping ensures that each test case is associated with the relevant test scenario it addresses. Further, the test cases may be grouped together based on the test scenarios they belong to. Test cases that validate similar functionalities or behaviors within a specific scenario may be grouped together to streamline the testing process.

In an embodiment, at block 414, Function Coverage Weight is applied to test cases to prioritize and assess the coverage of different functions within the software system. Function Coverage Weight quantifies the presence and importance of specific functions in the test cases, allowing for a targeted approach to testing based on the frequency and significance of each function. For example, in a scenario where Function part A is present in 100% of test cases, Function part B in 60% of cases, Function part C in 40% of cases, and Function part D in 10% of cases, the Function Coverage Weight may be calculated as follows.

Function part A is present in 100% of test cases, so Function part A may be assigned a higher Function Coverage Weight to indicate its importance and widespread coverage across the testing scenarios. Function part B is present in 60% of cases, so Function part B may receive a moderate Function Coverage Weight, reflecting its importance but not as extensive coverage as Function part A. Function part C is present in 40% of cases, so Function part C may have a lower Function Coverage Weight compared to Function parts A and B, indicating its lesser coverage and potentially lower priority in testing. Function part D is present in 10% of cases, so Function part D may have the lowest Function Coverage Weight, signifying its limited coverage and potentially lower criticality in the testing process. By applying Function Coverage Weight to test cases in this manner, testing efforts can be focused on functions with higher weights, ensuring thorough testing coverage of critical functionalities while optimizing testing resources and prioritizing testing activities based on the importance and frequency of functions within the software system.

In an embodiment, the test scenarios are stored in the test scenario library 408 and are refactored and stored in the test case library 406 to streamline the testing process and enhance the organization of test cases based on specific scenarios. Once the test scenarios are stored in the test scenario library 408, they undergo a refactoring process to transform them into executable test cases. This refactoring involves breaking down the high-level scenarios into detailed steps, actions, or conditions that can be directly executed as test cases. The refactored test cases are then stored in the test case library 406. The refactored test cases in the test case library 406 are organized and structured based on the specific scenarios they address. Each test case is associated with a particular test scenario, ensuring that the test cases are aligned with the intended functionalities or behaviors to be tested. By refactoring and storing test scenarios as test cases in the test case library 406, the testing process becomes more structured, efficient, and focused on validating specific functionalities or behaviors within the software system.

In an embodiment, the test case library 406 is restructured according to a graph data structure that represents different test cases executed by assembling test case units through graph traversal based on different scenarios. This restructuring process involves organizing and structuring test cases within a graph data structure to facilitate efficient test case execution and management across various testing scenarios. Initially, the test cases stored in the test case library 406 are mapped to the corresponding test scenarios based on the functionalities, behaviors, or user interactions they cover. Each test case unit represents a specific test case or a set of test steps that validate a particular aspect of the software system.

In an embodiment, the graph data structure is then utilized to represent the relationships between different test cases, test case units, and testing scenarios. Nodes in the graph correspond to individual test case units, while edges represent the connections or dependencies between these units based on the testing scenarios they address. During graph traversal, the test case units are assembled and executed based on the specific testing scenarios defined in the graph structure. By traversing the graph, the test case units are sequenced and executed in a logical order that aligns with the intended functionalities or behaviors to be tested within each scenario.

Accordingly, the graph data structure enables the systematic execution of test cases by following the paths defined by the graph traversal algorithm. This approach ensures that test cases are executed in a structured and organized manner, covering different scenarios and functionalities as represented in the graph structure. By restructuring the test case library 406 according to a graph data structure and executing test cases by assembling test case units through graph traversal based on different scenarios, the testing process becomes more systematic, organized, and effective in validating the software system across various testing scenarios and functionalities.

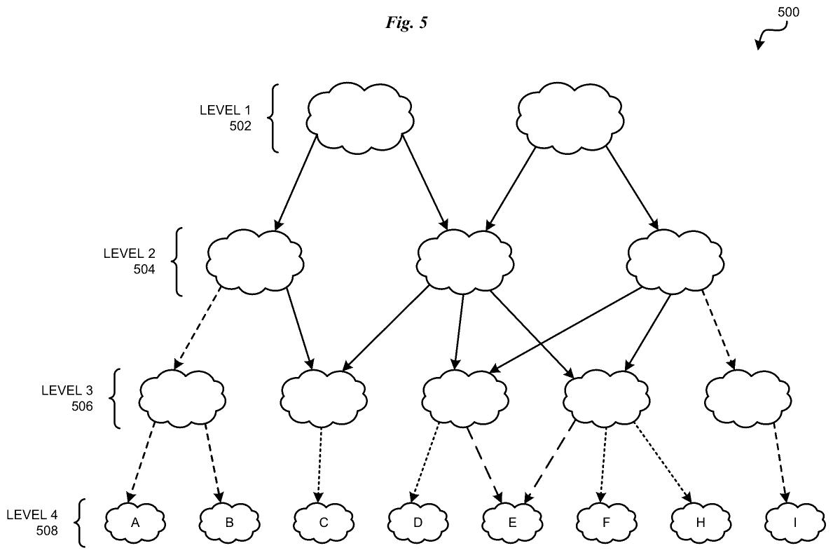

With reference to FIG. 5, this figure depicts a graph diagram of an example process for test case factorization optimization in accordance with an illustrative embodiment. In the illustrated embodiment, the graph data structure includes a tree graph 500 comprising a first level 502, a second level 504, a third level 506, and a fourth level 508.

In an embodiment, test case units are stored on a tree graph data structure to organize and represent the relationships between different test units in a hierarchical manner. In this structure, the roots, leaves, nodes, and edges play distinct roles in defining the hierarchy and connections between the test case units.

The roots in the graph data structure represent the starting points or top-level nodes of the hierarchy. These roots serve as the primary nodes from which the tree branches out, indicating the initial test case units or functionalities from which the testing process begins. The leaves in the tree graph data structure represent the end points or bottom-level nodes of the hierarchy. These leaves signify the final test case units or functionalities that do not have any child nodes branching out from them. The leaves represent the smallest, indivisible test case units that directly validate specific functionalities or behaviors within the software system.

The remaining nodes in the tree graph data structure represent the intermediate levels or layers between the roots and leaves. These nodes correspond to the test case units that are organized hierarchically based on their relationships and dependencies. Each node may have child nodes branching out from it, representing the decomposition of test case units into smaller, more granular units. The edges between the nodes in the tree graph data structure represent the connections or relationships between the test case units. These edges define the parent-child relationships between nodes, indicating how the test case units are structured and organized within the hierarchy. The edges establish the flow of information, dependencies, and execution sequence between the test case units as they are traversed and executed during the testing process.

In the illustrated embodiment, a Directed Acyclic Graph (DAG) is constructed to store and organize test cases in a structured and efficient manner within a testing framework. A DAG is a graph data structure that consists of nodes connected by directed edges, where the edges have a specific direction and do not form any cycles. In an embodiment, each node in the DAG represents a specific test case unit or a set of test steps that validate a particular functionality, behavior, or scenario within the software system. In some embodiments, nodes can be labeled with identifiers or descriptions to indicate the content or purpose of the test case unit.

In an embodiment, the directed edges in the DAG represent the relationships or dependencies between different test case units. As shown in the illustrated embodiment, an edge from a node of a first level 502 to node in the second level 504 indicates that there is a dependency or sequence between the test case units represented by these nodes. For example, if test case unit B is dependent on the successful execution of test case unit A, there would be a directed edge from A to B.

The DAG structure allows for the representation of hierarchical relationships and dependencies between test case units. Test case units can be organized in a hierarchical manner, with parent nodes representing higher-level functionalities and child nodes representing more granular test case units that validate specific aspects of the system. The acyclic property of the DAG ensures that there are no cycles or loops in the graph structure. This property is useful in the context of test cases to prevent redundant or infinite loops in the testing process, ensuring that test cases are executed in a structured and non-repetitive manner. Test cases can be organized in the DAG based on different testing scenarios or functionalities. Test units of nodes can be grouped together based on the specific scenarios they address, allowing for targeted testing of different user interactions, system behaviors, or functional requirements. The DAG structure facilitates the traversal and execution of test cases in a logical sequence based on the directed edges. Test cases can be executed by following the paths defined by the edges, ensuring that dependencies between test case units are maintained and that the testing process progresses in an organized manner.

In an embodiment, different path traversals representing sequences of actions assembled from test units can be triggered based on different testing scenarios defined by tests to execute based on the scenario. This approach allows for the execution of specific sequences of actions tailored to different scenarios within the testing framework. In an embodiment, each testing scenario is defined by a set of tests or test cases that need to be executed to validate a particular functionality, behavior, or user interaction within the software system. These scenarios outline the specific conditions, inputs, and expected outcomes for the testing process. The sequences of actions assembled from test units represent the steps or operations that need to be executed to validate a specific scenario. Each path traversal corresponds to a sequence of test units that are interconnected based on dependencies and relationships defined in the testing framework.

Further, based on the defined testing scenarios, different path traversals can be triggered to execute the corresponding sequences of actions. When a specific scenario is selected for testing, the associated path traversal is activated to execute the sequence of test units that validate that scenario. Accordingly, the triggering of path traversals based on testing scenarios allows for dynamic execution of test cases tailored to different testing conditions. By selecting a specific scenario, the testing framework can automatically initiate the corresponding path traversal to execute the required tests in the defined sequence. The execution of path traversals based on testing scenarios enables scenario-based validation of the software system.

In an embodiment, a weight function can be applied to the nodes of the graph 500 such that the weight of each node is calculated based on the number of connections of each node to its parent node, child node, or both. This weight calculation method facilitates prioritization of significant nodes within the graph structure based on their relationships and/or dependencies. For example, for nodes with parent-child connections, the weight of a node can be calculated based on the number of child nodes it is connected to. A node with multiple child nodes may be assigned a higher weight to indicate its importance in branching out to multiple functionalities or scenarios within the testing framework.

As another example, the weight of a node can also be calculated based on the number of parent nodes it is connected to. Nodes with multiple parent nodes may be assigned a higher weight to signify their role in aggregating functionalities or behaviors from different branches of the graph structure. As another example, in cases where a node has both parent and child connections, the weight calculation can consider the total number of connections to both parent and child nodes. This comprehensive approach provides a holistic view of the node's significance in terms of branching out to different functionalities and aggregating dependencies from multiple sources.

The weight function can assign weight values to nodes based on the calculated connections, with nodes having more connections receiving higher weights. This weight assignment helps prioritize nodes that play a central role in the graph structure, have multiple dependencies, and/or are critical for the overall testing process. Accordingly, nodes with higher weights may indicate important functionalities, key decision points, and/or central components within the testing framework. By applying the weight function based on connections to parent and child nodes, the graph structure can be optimized to focus on important nodes, streamline dependencies, and enhance the efficiency and effectiveness of the testing process. By applying a weight function to the nodes of the DAG based on the number of connections to parent nodes, child nodes, or both, the testing framework can prioritize and assess the significance of nodes within the graph structure, enabling targeted testing, optimized traversal, and efficient management of dependencies in the testing process.

In an embodiment, the construction of the graph 500 enables performing a process for weighted automatic testing, as described in greater detail herein. In an embodiment, weighted automatic testing using graph traversal involves assigning weights to nodes in a graph data structure representing test cases and test units. These weights may be calculated based on specific criteria such as the complexity, criticality, or frequency of each node's connections to parent or child nodes. The weight values assigned to nodes determine their importance in the testing process and guide the traversal algorithm to prioritize nodes with higher weights during test case execution.

In an embodiment, during graph traversal, the algorithm follows a path that maximizes the cumulative weight of the traversed nodes. By incorporating weights into the traversal process, the testing framework can optimize the testing sequence, focus on high-priority test cases, and efficiently validate key functionalities within the software system. The weighted automatic testing approach enhances the effectiveness and efficiency of the testing process by dynamically adjusting the traversal path based on the assigned weights, ensuring thorough coverage of critical functionalities and targeted testing of key scenarios.

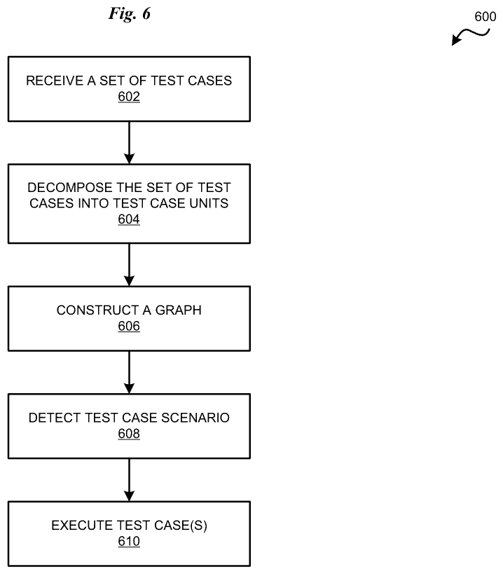

With reference to FIG. 6, this figure depicts a flowchart of an example process of test case factorization optimization, in accordance with an illustrative embodiment. In an embodiment, the test case factorization optimization module 200 of FIGS. 1 and 2, test case factorization optimization module 300 of FIG. 3, and/or system 400 of FIG. 4, carries out some or all aspects of the process 600.

In an embodiment, at step 602, the process receives a set of test cases from a test case database. In an embodiment, at step 604, the process decomposes each test case of the set of test cases into test case units. In an embodiment, at step 606, the process constructs a graph data structure based on the case units corresponding to the test cases of the set of test cases. In an embodiment, at step 608, the process detects a first test case scenario. In an embodiment, at step 610, the process traverses a portion of paths of the graph data structure to execute a portion of the set of test cases based on the first test case scenario. This traversal involves following specific paths in the graph structure to execute the corresponding test case units that validate the functionalities or behaviors defined by the test case scenario. By following these steps, the process systematically decomposes test cases, constructs a graph data structure, detects test case scenarios, and executes test cases based on the identified scenarios, enabling efficient and targeted testing of the software system.

It is contemplated herein that test case scenarios may be defined according to the type of software application or component to be tested in order to ensure comprehensive coverage and effective validation of the software system. In some embodiments, the definition of test case scenarios determines the scope and/or objectives of the testing process. Test case scenarios may be defined by identifying the specific functionalities, features, or user interactions within the software application or component that need to be tested. Each functionality may represent a distinct aspect of the software system that requires validation. For user-centric applications, test case scenarios may be defined based on different use cases and user interactions. Example test case scenarios may include, but are not limited to, login processes, data entry forms, navigation flows, and other user actions that need to be tested.

Further, test case scenarios can also be defined based on the expected behaviors and responses of the software system under different conditions. Scenarios may cover error handling, boundary conditions, performance benchmarks, and other system behaviors that require validation. In the case of software components or systems that interact with external services or components, test case scenarios may be defined based on integration points. S Example test case scenarios may include, but are not limited to, data exchange, API interactions, and integration testing.

Further, test case scenarios for regression testing may be defined based on changes or updates to the software application or component. Scenarios may cover the impact of modifications on existing functionalities, ensuring that new changes do not introduce regressions or unexpected behavior. Test case scenarios may also focus on edge cases and exception handling to validate the robustness and reliability of the software application or component. Example test case scenarios may include, but are not limited to, stress testing, boundary testing, and error scenarios to assess the system's resilience under adverse conditions. Accordingly, by defining test case scenarios based on the type of software application or component to be tested, embodiments of the automated process herein may be can tailored address specific functionalities, user interactions, system behaviors, and integration points, ensuring thorough validation and effective testing coverage of the software system.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
decomposing each test case of a set of test cases into a set of test case units;
constructing a graph data structure based on the set of test case units, wherein each path of the graph data structure corresponds to a test case of the set of test cases;
detecting a first test case scenario, wherein the first test case scenario corresponds to a first portion of the set of test cases;
traversing, upon detection of the first test case scenario, a first portion of paths of the graph data structure, wherein traversing a path of the first portion of paths causes assembling a test case of the first portion of test cases; and
executing each test case assembled as a result of each path traversal of the first portion of paths of the graph data structure.

2. The computer-implemented method of claim 1, further comprising assigning each node of the graph data structure a weight value based on a number of connections to other nodes.

3. The computer-implemented method of claim 2, wherein the number of connections to other nodes corresponds to a number of connections to child nodes.

4. The computer-implemented method of claim 2, wherein the number of connections to other nodes corresponds to a number of connections to parent nodes.

5. The computer-implemented method of claim 2, wherein the number of connections to other nodes corresponds to a combination of child nodes and parent nodes connected to the node.

6. The computer-implemented of claim 2, wherein traversing each path of the first portion of paths of the graph data structure is executed in a sequence based at least in part on a cumulative weight value corresponding to execution of each path.

7. A computer program product comprising one or more computer readable storage media, and program instructions collectively stored on the one or more computer readable storage media, the program instructions executable by a processor to cause the processor to perform operations comprising:
decomposing each test case of a set of test cases into a set of test case units;
constructing a graph data structure based on the set of test case units, wherein each path of the graph data structure corresponds to a test case of the set of cases;
detecting a first test case scenario, wherein the first test case scenario corresponds to a first portion of the set of test cases;
traversing, upon detection of the first test case scenario, a first portion of paths of the graph data structure, wherein traversing a path of the first portion of paths causes assembling a test case of the first portion of test cases; and
executing each test case assembled as a result of each path traversal of the first portion of paths of the graph data structure.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising assigning each node of the graph data structure a weight value based on a number of connections to other nodes in the graph data structure.

11. The computer program product of claim 10, wherein the number of connections to other nodes in the graph data structure comprises a number of connections to child nodes.

12. The computer program product of claim 10, wherein the number of connections to other nodes in the graph data structure comprises a number of connections to parent nodes.

13. The computer program product of claim 10, wherein the number of connections to other nodes in the graph data structure comprises a combination of a number of connections to child nodes and a combination to parent nodes.

14. The computer program product of claim 10, wherein traversing each path of the first portion of paths of the graph data structure is executed in a sequence based at least in part on a cumulative weight value corresponding to executing each path.

15. A computer system comprising a processor and one or more computer readable storage media, and program instructions collectively stored on the one or more computer readable storage media, the program instructions executable by the processor to cause the processor to perform operations comprising:
decomposing each test case of a set of test cases into a set of test case units;
constructing a graph data structure based on the set of test case units, wherein each path of the graph data structure corresponds to a test case of the set of cases;
detecting a first test case scenario, wherein the first test case scenario corresponds to a first portion of the set of test cases;
traversing, upon detection of the first test case scenario, a first portion of paths of the graph data structure, wherein traversing a path of the first portion of paths causes assembling a test case of the first portion of test cases; and
executing each test case assembled as a result of each path traversal of the first portion of paths of the graph data structure.

16. The computer system of claim 15, further comprising assigning each node of the graph data structure a weight value based on a number of connections to other nodes in the graph data structure.

17. The computer system of claim 16, wherein the number of connections to other nodes in the graph data structure comprises a number of connections to child nodes.

18. The computer system of claim 16, wherein the number of connections to other nodes in the graph data structure comprises a number of connections to parent nodes.

19. The computer system of claim 16, wherein the number of connections to other nodes in the graph data structure comprises a combination of a number of connections to child nodes and a combination to parent nodes.

20. The computer system of claim 16, wherein traversing each path of the first portion of paths of the graph data structure is executed in a sequence based at least in part on a cumulative weight value corresponding to executing each path.
